(19) United States
(12) Patent Application Publication
(10) Pub. No.: US 2012/0124112 A1
(43) Pub. Date: May 17, 2012

(54) Portable Electronic Financial Calculator and Method of Calculating Financial Information

(76) Inventor: Zerah Izhak Goldhaber, Toronto (CA)

(21) Appl. No.: 12/945,500

(22) Filed: Nov. 12, 2010

(51) Int. Cl. G06F 3/01

(52) U.S. Cl. 708/132

(57) ABSTRACT

The present invention relates to a user-friendly, portable electronic financial calculator for automatically calculating information pertaining to savings and loans, and a method for calculating information pertaining to savings and loans using a portable financial calculator. The calculator is pre-programmed with various problems, presented in plain language, regarding the time value of money from which the user selects. The user is then asked various questions, in plain language, pertaining to the problem selected which the user answers by selecting the appropriate inputs. After all of the applicable questions are asked and answered, the calculator calculates the solution to the problem selected based on the user's inputs and based on a pre-programmed mathematical relationship between the prompted inputs and the problem selected.

### FIELD OF THE INVENTION

The present invention relates to a portable electronic financial calculator for automatically calculating information pertaining to savings and loans, and a method for calculating information pertaining to savings and loans using a portable electronic financial calculator. More specifically, the portable electronic financial calculator is pre-programmed with various financial problems stated in plain language, from which the user selects, and prompts the user for information by sequentially asking various pre-programmed plain language questions pertaining to the problem selected.

### BACKGROUND OF THE INVENTION

Financial planning is a task which many people find daunting and complex. People often spend large sums of money to consult financial planners to assist them with their retirement plans and other financial matters. Other people invest in complex and expensive computer software designed to be run on home computers and which cannot be practically operated using portable devices. Still other people choose to avoid the task of financial planning altogether, leaving them ill-prepared for their future.

In an attempt to make financial planning more accessible to ordinary members of the public, various portable financial calculators have been designed which perform specific calculations relating to financial matters either based on pre-programmed formulae or on formulae which the user enters. Unfortunately, such financial calculators tend to be difficult to use, requiring training and extensive review of instruction manuals before the average person can become capable of using the calculator.

A device that attempts to address this problem is disclosed in U.S. Pat. No. 3,863,060 which issued to Rode et al. on Jan. 28, 1975. This device is a hand-held calculator that performs a plethora of business calculations. This device would be difficult for a lay person to use for various reasons. For example, the user is not assisted in selecting the problem to be solved. Rather the user must review the instruction manual to determine which button or buttons correspond to which problems. Further, the device requires the user to define the variables in a problem, to be aware of generally accepted business symbols, such as i for interest per period and PMT for payment per period, and to enter the required information for solving a problem without any plain-language prompting. The input means of this device is also complex, with the keys bearing mathematical symbols that are unfamiliar to most laypersons. Some keys have more than one function assigned to them, requiring the user to refer to coded legends above the keys, the legends also consisting of mathematical symbols that are unfamiliar to the typical lay user.

Another device that attempts to address this problem is disclosed in U.S. Pat. No. 5,245,536 which issued to Hsieh on Sep. 14, 1993. This device performs calculations relating to four applications: loan and annuities, savings, rates versus yield, and bonds. While the device is capable of prompting inputs using plain language, it requires all variables to be input on one screen at the same time and for the user to specify which variable in the calculation is unknown. This makes the device non-user-friendly and requires the user to have some mathematical fluency. Further, the keypad of this device is complicated and cluttered. For example, it assigns each financial problem to a specific key on the keypad, and requires a separate key to store information.

What is desired is some apparatus and method for allowing the average layperson to immediately and without difficulty perform financial planning calculations. In particular, what is desired is an apparatus and method whereby the user can easily select the problem which he or she wishes to solve, presented in plain language, and is then prompted, also in plain language, to enter inputs.

### SUMMARY OF THE INVENTION

The present invention relates to a portable electronic financial calculator for automatically calculating information pertaining to savings and loans, and a method for calculating information pertaining to savings and loans using a portable electronic financial calculator.

According to one aspect of the present invention, there is provided a portable electronic financial calculator for automatically calculating information pertaining to the time value of money, comprising:
display panel means for displaying various pre-programmed plain language problems for selection, for pre-programmed plain language prompting of certain inputs corresponding to said plain language problem selected, and for receiving entered data in response to said plain language prompting;
input means operatively connected to said display panel means, for selecting among said plain language problems and for inputting information in response to said plain language prompting;
memory means operatively connected to said input means, for storing selection among said plain language problems, for storing said information inputted by said input means, and for storing mathematical relationship between said information and said plain language problem selected;
calculating means operatively connected to said memory means for calculating solution to said plain language problem selected, using said mathematical relationships and said information inputted in response to said plain language prompting; and
output means operatively connected to said calculating means and said display panel means for presenting said solution to said plain language problem selected on said display panel means.

According to another aspect of the present invention, there is provided a method for calculating financial information pertaining to the time value of money using a portable electronic financial calculator comprising the steps of:
(a) viewing and navigating through various pre-programmed plain language problems capable of being displayed on a display panel means comprised by said portable electronic financial calculator;
(b) selecting one of said plain language problems;
(c) prompting, by means of plain language prompting displayed on said display panel means, of certain inputs corresponding to said plain language problem selected;
(d) inputting said inputs into said portable financial calculator through input means comprised by said portable financial calculator in response to said prompting;
(e) automatically storing said inputs into a memory means comprised by said portable electronic financial calculator;
(f) calculating a solution to the said problem based on said inputs and based on a pre-programmed mathematical relationship between said inputs and said plain language problem selected;
(g) displaying said solution on said display panel means.

In yet another aspect of the present invention, only one problem may be selected at a time.

In yet another aspect of the present invention, the inputs are prompted one input at a time.

These are merely some of the innumerable illustrative aspects of this present invention and should not be deemed an all-inclusive listing.

### BRIEF DESCRIPTION OF THE DRAWINGS

For a better understanding of the present invention, reference may be made to the accompanying drawings in which:

FIG. 1A illustrates a perspective view of an embodiment of the portable electronic financial calculator of the present invention;

FIG. 1B illustrates an exploded view of the back of an embodiment of the portable electronic financial calculator;

FIG. 2A through 2F illustrate a schematic process diagram of an embodiment of the portable electronic financial calculator;

FIG. 3 illustrates a block diagram of a basic functional schematic for the components of an integrated circuit employed by an embodiment of the portable electronic financial calculator;

FIG. 4A illustrates a perspective view of a protective case for an embodiment of the portable electronic financial calculator;

FIG. 4B illustrates a top view of the back of the protective case for an embodiment of the portable electronic financial calculator.

### DETAILED DESCRIPTION OF THE PREFERRED EMBODIMENTS

The present invention relates to a portable electronic financial calculator for automatically calculating information pertaining to savings and loans, and a method for calculating information pertaining to savings and loans using a portable electronic financial calculator.

The following description is of preferred embodiments of the invention, by way of example only, without limitation to the combination of features necessary for carrying the invention into effect.

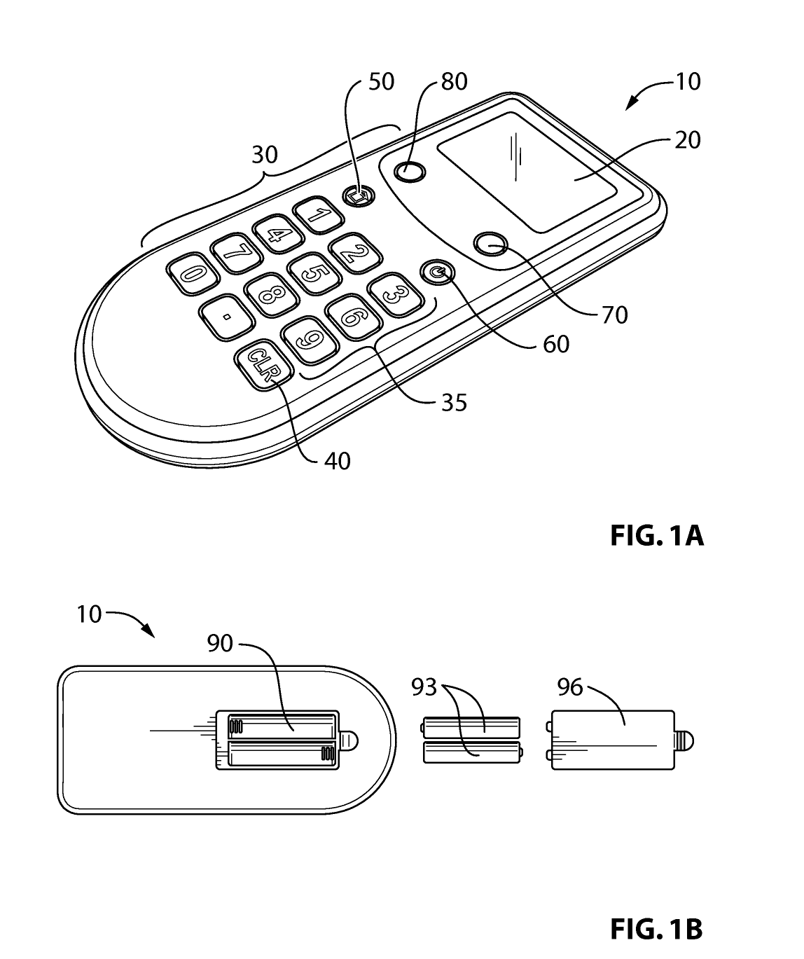

FIG. 1A shows an embodiment of the portable electronic financial calculator 10 of the present invention. The calculator 10 is sized and shaped to fit comfortably in one hand. The calculator 10 includes a display screen 20 and a keyboard 30. The display screen 20 is illuminated by light means (not shown) during use. The keyboard 30 is simple and uncluttered, preferably including only 16 buttons or keys (for the purposes of this specification, the terms ‘buttons’ and ‘keys’ are used interchangeably and have the same meaning), namely keys for the digits 0 to 9 and a decimal point 35, a clear button 40, a home button 50, a power button 60, and two selection keys 70, 80, one of said selection keys being the OK key 70 and the other of said selection buttons being the NEXT key 80. The determination of which of the two selection keys is to be the OK key 70 and which is to be the NEXT key 80 is arbitrary, and the invention encompasses both possible permutations. The keys for the digits 0 to 9 and decimal point 35 allow the user to enter numerical values in response to the plain language questions as elaborated upon below. The clear button 40 is preferably marked with the letters CLR and allows the user to delete numerical information entered. The home button 50 allows the user to be returned to the home screen, which is the screen at which the user is prompted to choose a financial problem to solve <120>.

Referring now to FIG. 1B, there is shown the back of the calculator 10 in which there is a battery compartment 90. In the preferred embodiment, the battery compartment 90 holds two AAA batteries 93 which power the calculator 10. The batteries 93 are concealed by a battery compartment cover 96 which engages the back of the calculator 10.

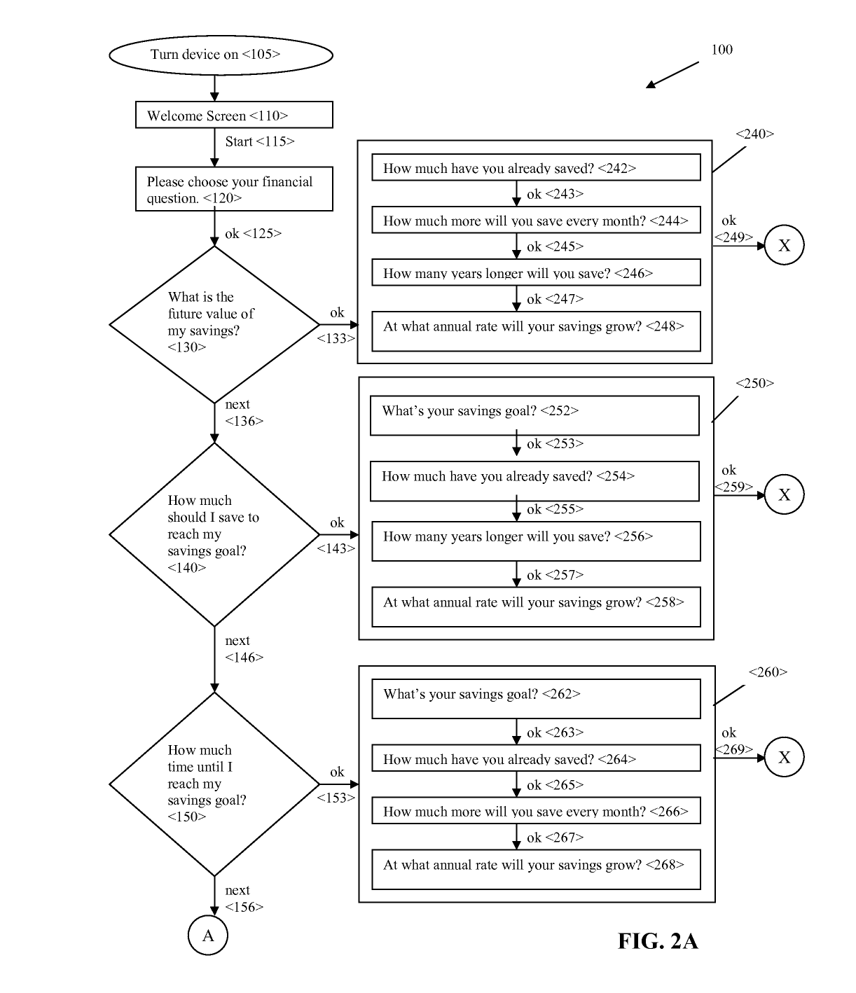

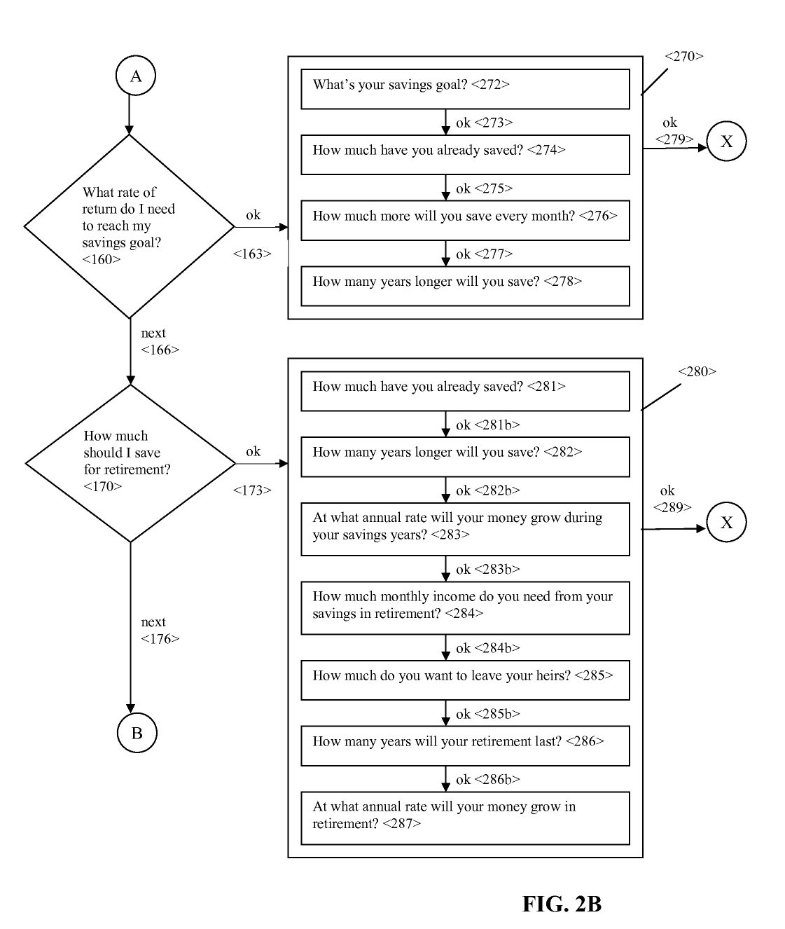

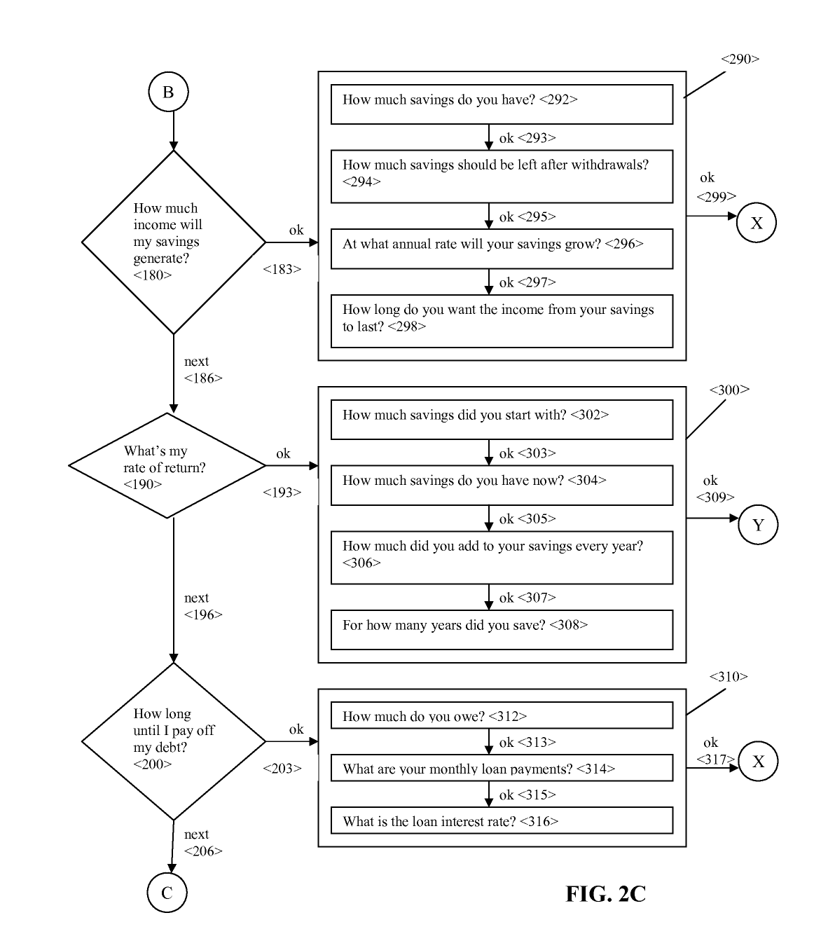

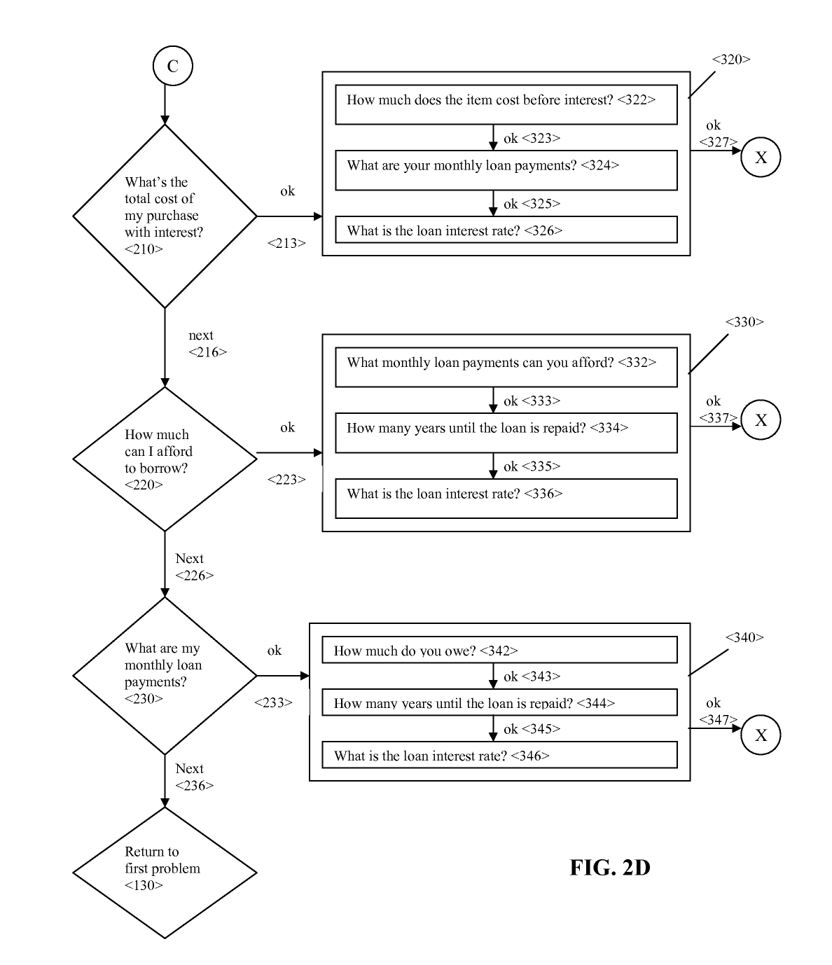

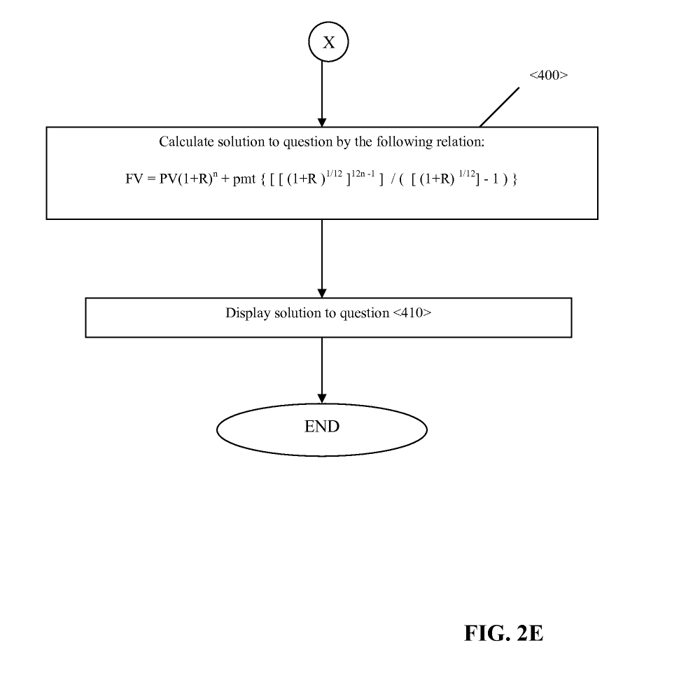

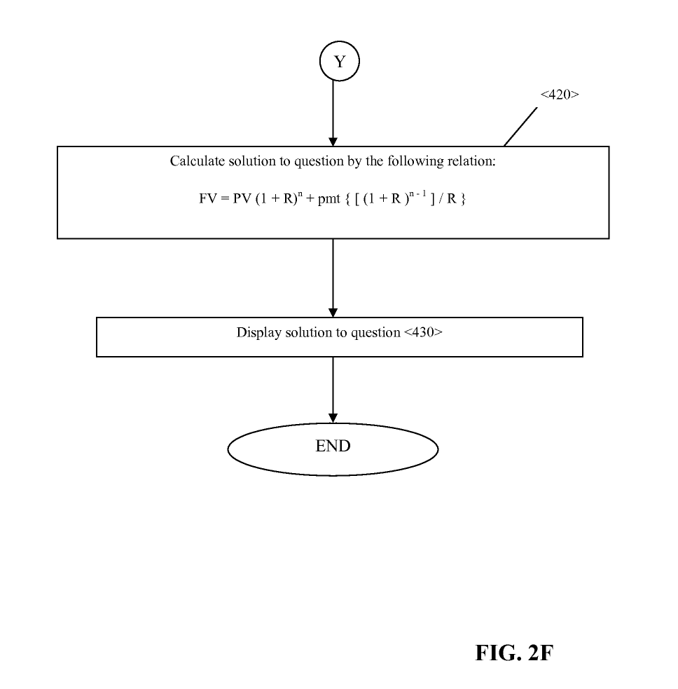

FIGS. 2A, 2B, 2C, 2D, 2E, and 2F illustrate a flowchart of the portable electronic financial calculator 10 of the present invention and is denoted generally by reference numeral 100. A programmer skilled in the art could utilize the flowchart to program any of a wide variety of electronic calculators, controllers or computers in a wide variety of programming languages. In the description of the flowchart in FIGS. 2A to 2F, the functional explanation marked with numerals in angle brackets, <nnn>, will refer to the flowchart blocks bearing that number.

The first step in the process <105> is to activate or turn-on the calculator 10. The power button 60, as shown in FIG. 1A, performs this function. This causes information to appear on the display screen 20. The display screen 20 is preferably a liquid crystal display. However, any electronic display can be employed such as a cathode ray tube (‘CRT’), and electroluminescent display, or a plasma display.

As shown in FIG. 2A, after the calculator 10 is turned on, an optional welcome screen appears <110> on the display screen 20 and the user is prompted to input the command “START” by pressing the OK key 70, <115>. The user is then prompted to choose a financial question to solve <120>. This prompt is the home screen which the user can return to at any time by pressing the home key 50. The user then inputs the command “OK” <125> by pressing the OK key 70.

The user is then presented with the first of eleven problems, namely “What is the future value of my savings?” <130> which is displayed on the display screen 20. The user may either select this problem to solve by pressing the OK key 70, <133>, or may view the next problem by pressing the NEXT key 80, <136>. If the user presses the OK key 70, <133>, the user will then be prompted to answer a series of four plain language questions <240> in the following order: “How much have you already saved?” <242>, “How much more will you save every month?” <244>, “How many years longer will you save?” <246>, and “At what annual rate will your savings grow?” <248>. The user moves from one of said four plain language questions to the next upon entering the numerical value corresponding to each question and pressing the OK key 70, <243>, <245>, <247>. Once the last of these four questions is answered by the user and the user presses the OK key 70, <249>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “The future value of your savings is $[solution]”, where [solution] is the numerical solution to the above mathematical relation.

If the user chooses to view the next problem by pressing the NEXT key 80, <136>, as described above, the user will then be presented with the second problem, namely “How much should I save to reach my savings goal?”<140> displayed on the display screen 20. The user may either select this problem to solve by pressing the OK key 70, <143>, or may view the next problem by pressing the NEXT key 80, <146>. If the user presses the OK key 70, <143>, the user will then be prompted to answer a series of four plain language questions <250> in the following order: “What's your savings goal?” <252>, “How much have you already saved?” <254>, “How many years longer will you save?” <256>, and “At what annual rate will your savings grow?” <258>. The user moves from one of said four plain language questions to the next upon entering the numerical value corresponding to each question and pressing the OK key 70, <253>, <255>, <257>. Once the last of these four questions is answered by the user and the user presses the OK key 70, <259>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “To reach your goal, here's how much you should save every month $[solution]”, where [solution] is the numerical solution to the above mathematical relation.

If the user chooses to view the next problem by pressing the NEXT key 80, <146>, as described above, the user will then be presented with the third problem, namely “How much time until I reach my savings goal?”<150> displayed on the display screen 20. The user may either select this problem to solve by pressing the OK key 70, <153>, or may view the next problem by pressing the NEXT key 80, <156>. If the user presses the OK key 70, <153>, the user will then be prompted to answer a series of four plain language questions <260> in the following order: “What's your savings goal?” <262>, “How much have you already saved?” <264>, “How much more will you save every month?” <266>, and “At what annual rate will your savings grow?” <268>. The user moves from one of said four plain language questions to the next upon entering the numerical value corresponding to each question and pressing the OK key 70, <263>, <265>, <267>. Once the last of these four questions is answered by the user and the user presses the OK key 70, <269>, the calculator 10 calculates <400> the solution to the problem by means of the following relation:

FV=PV(1+R)ⁿ+pmt {[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “You'll reach your savings goal in [solution] years”, where [solution] is the numerical solution to the above mathematical relation.

If the user chooses to view the next problem by pressing the NEXT key 80, <156>, as described above, the user will then be presented with the fourth problem, namely “What rate of return do I need to reach my savings goal?”<160> displayed on the display screen 20. The user may either select this problem to solve by pressing the OK key 70, <163>, or may view the next problem by pressing the NEXT key 80, <166>. If the user presses the OK key 70, <163>, the user will then be prompted to answer a series of four plain language questions <270> in the following order: “What's your savings goal?” <272>, “How much have you already saved?” <274>, “How much more will you save every month?” <276>, and “How many years longer will you save?” <278>. The user moves from one of said four plain language questions to the next upon entering the numerical value corresponding to each question and pressing the OK key 70, <273>, <275>, <277>. Once the last of these four questions is answered by the user and the user presses the OK key 70, <279>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “To reach your goal, you'll need a rate of return of [solution] %”, where [solution] is the numerical solution to the above mathematical relation.

If the user chooses to view the next problem by pressing the NEXT key 80, <166>, as described above, the user will then be presented with the fifth problem, namely “How much should I save for retirement?”<170> displayed on the display screen 20. The user may either select this problem to solve by pressing the OK key 70, <173>, or may view the next problem by pressing the NEXT key 80, <176>. If the user presses the OK key 70, <173>, the user will then be prompted to answer a series of seven plain language questions <280> in the following order: “How much have you already saved?” <281>, “How many years longer will you save?” <282>, “At what annual rate will your money grow during your savings years?” <283>, “How much monthly income do you need from your savings in retirement?” <284>, “How much do you want to leave your heirs?” <285>, “How many years will your retirement last?” <286>, and “At what annual rate will your money grow in retirement?” <287>. The user moves from one of said seven plain language questions to the next upon entering the numerical value corresponding to each question and pressing the OK key 70, <281b>, <282b>, <283b>, <284b>, <285b>, <286b>. Once the last of these seven questions is answered by the user and the user presses the OK key 70, <289>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “Here's how much you should save every month for retirement $[solution]”, where [solution] is the numerical solution to the above mathematical relation.

If the user chooses to view the next problem by pressing the NEXT key 80, <176>, as described above, the user will then be presented with the sixth problem, namely “How much income will my savings generate?”<180> displayed on the display screen 20. The user may either select this problem to solve by pressing the OK key 70, <183>, or may view the next problem by pressing the NEXT key 80, <186>. If the user presses the OK key 70, <183>, the user will then be prompted to answer a series of four plain language questions <290> in the following order: “How much savings do you have?” <292>, “How much savings should be left after withdrawals?” <294>, “At what annual rate will your savings grow?” <296>, and “How long do you want the income from your savings to last?” <298>. The user moves from one of said four plain language questions to the next upon entering the numerical value corresponding to each question and pressing the OK key 70, <293>, <295>, <297>. Once the last of these four questions is answered by the user and the user presses the OK key 70, <299>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “Your savings will generate monthly income of $[solution]”, where [solution] is the numerical solution to the above mathematical relation.

If the user chooses to view the next problem by pressing the NEXT key 80, <186>, as described above, the user will then be presented with the seventh problem, namely “What's my rate of return?”<190> displayed on the display screen 20. The user may either select this problem to solve by pressing the OK key 70, <193>, or may view the next problem by pressing the NEXT key 80, <196>. If the user presses the OK key 70, <193>, the user will then be prompted to answer a series of four plain language questions <300> in the following order: “How much savings did you start with?” <302>, “How much savings do you have now?” <304>, “How much did you add to your savings every year?” <306>, and “For how many years did you save?” <308>. The user moves from one of said four plain language questions to the next upon entering the numerical value corresponding to each question and pressing the OK key 70, <303>, <305>, <307>. Once the last of these four questions is answered by the user and the user presses the OK key 70, <309>, the calculator 10 calculates <420> the solution to the problem by means of the following relation:

FV=PV(1+R)ⁿ+pmt{[(1+R)ⁿ⁻¹]/R} where FV denotes future value, PV denotes present value, n denotes the number of years, pmt denotes payment paid at the end of each year, and R denotes the annual interest rate. The solution is then displayed <430> on the display screen 20 within a plain language statement as follows: “Your annual rate of return is [solution] %”, where [solution] is the numerical solution to the above mathematical relation.

If the user chooses to view the next problem by pressing the NEXT key 80, <196>, as described above, the user will then be presented with the eighth problem, namely “How long until I pay off my debt?”<200> displayed on the display screen 20. The user may either select this problem to solve by pressing the OK key 70, <203>, or may view the next problem by pressing the NEXT key 80, <206>. If the user presses the OK key 70, <203>, the user will then be prompted to answer a series of three plain language questions <310> in the following order: “How much do you owe?” <312>, “What are your monthly loan payments?” <314>, and “What is the loan interest rate?” <316>. The user moves from one of said three plain language questions to the next upon entering the numerical value corresponding to each question and pressing the OK key 70, <313>, <315>. Once the last of these three questions is answered by the user and the user presses the OK key 70, <317>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “Your debt will be paid off in [solution] years”, where [solution] is the numerical solution to the above mathematical relation.

If the user chooses to view the next problem by pressing the NEXT key 80, <206>, as described above, the user will then be presented with the ninth problem, namely “What's the total cost of my purchase with interest?”<210> displayed on the display screen 20. The user may either select this problem to solve by pressing the OK key 70, <213>, or may view the next problem by pressing the NEXT key 80, <216>. If the user presses the OK key 70, <213>, the user will then be prompted to answer a series of three plain language questions <320> in the following order: “How much does the item cost before interest?” <322>, “What are your monthly loan payments?” <324>, and “What is the loan interest rate?” <326>. The user moves from one of said three plain language questions to the next upon entering the numerical value corresponding to each question and pressing the OK key 70, <323>, <325>. Once the last of these three questions is answered by the user and the user presses the OK key 70, <327>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “The real cost of that item with interest is $[solution]”, where [solution] is the numerical solution to the above mathematical relation.

If the user chooses to view the next problem by pressing the NEXT key 80, <216>, as described above, the user will then be presented with the tenth problem, namely “How much can I afford to borrow?”<220> displayed on the display screen 20. The user may either select this problem to solve by pressing the OK key 70, <223>, or may view the next problem by pressing the NEXT key 80, <226>. If the user presses the OK key 70, <223>, the user will then be prompted to answer a series of three plain language questions <330> in the following order: “What monthly loan payments can you afford?” <332>, “How many years until the loan is repaid?” <334>, and “What is the loan interest rate?” <336>. The user moves from one of said three plain language questions to the next upon entering the numerical value corresponding to each question and pressing the OK key 70, <333>, <335>. Once the last of these three questions is answered by the user and the user presses the OK key 70, <337>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “You can afford to borrow $[solution]”, where [solution] is the numerical solution to the above mathematical relation.

If the user chooses to view the next problem by pressing the NEXT key 80, <226>, as described above, the user will then be presented with the eleventh and final problem, namely “What are my monthly loan payments?”<230> displayed on the display screen 20. The user may select this problem to solve by pressing the OK key 70, <233>, or may return to the first problem <130> by pressing the NEXT key 80, <236>. If the user presses the OK key 70, <233>, the user will then be prompted to answer a series of three plain language questions <340> in the following order: “How much do you owe?” <342>, “How many years until the loan is repaid?” <344>, and “What is the loan interest rate?” <346>. The user moves from one of said three plain language questions to the next upon entering the numerical value corresponding to each question and pressing the OK key 70, <343>, <345>. Once the last of these three questions is answered by the user and the user presses the OK key 70, <347>, the calculator 10 calculates <400> the solution to the problem by means of the following relation:

FV=PV(1+R)ⁿ+pmt{[[(1+R)^{1/12}]¹²ⁿ⁻¹]/([(1+R)^{1/12}]−1)} where FV denotes future value, PV denotes present value, n denotes the number of years, pmt denotes payment paid at the end of each month, and R denotes the annual interest rate. The solution is then displayed <410> on the display screen 20 within a plain language statement as follows: “Your monthly loan payments are $[solution]”, where [solution] is the numerical solution to the above mathematical relation.

With respect to each of the eleven problems, for each of the series of plain language questions asked, the user has the option of returning to the previous screen by inputting the command “BACK” (not shown) by pressing the NEXT key 80. For example, with respect to problem eleven, “What are my monthly loan payments?” <230>, when the first of the three questions, namely “How much do you owe?” <342> is displayed on the display screen 20, the user will have the option of returning to the previous screen bearing the statement of the problem “What are my monthly loan payments?” <230> by pressing the NEXT key 80. Likewise, when the second of the three questions, namely “How many years until the loan is repaid” <344> is displayed on the display screen 20, the user will have the option of returning to the first of the three questions “How much do you owe?” <342> by pressing the NEXT key 80, and so on.

Additionally, with respect to each of the eleven problems, once the solution to the problem is displayed, the user will have the option of returning to the home screen <120> by inputting the command “DONE” by pressing the OK key 70. The user will also have the option of returning to the last of the series of questions with respect to that problem by inputting the command “BACK” by pressing the NEXT key 80 as described above.

Should a solution to a problem be meaningless in the real world, the word ERROR will appear on the display screen 20 rather than the solutions described above. For example, if the interest rate, R, is entered as zero for any of the eleven problems, the numerical solution will be infinity, and the word ERROR would appear on the display screen 20.

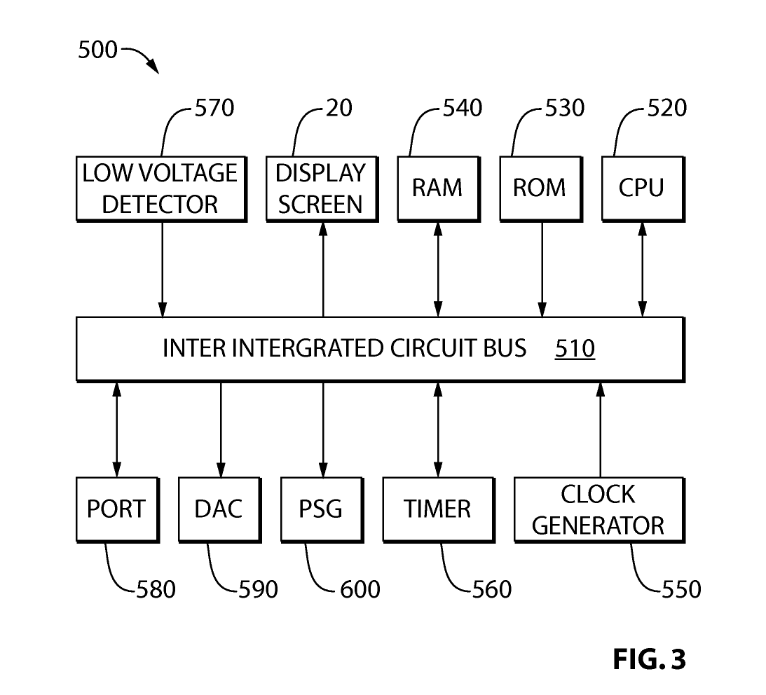

The portable electronic financial calculator 10 employs an integrated circuit of the kind that is generally used in calculators as is known in the art. An example of such an integrated circuit is denoted generally by numeral 500 in FIG. 3. FIG. 3 is a block diagram schematic that indicates the general components of the integrated circuit 500 and their associated relationship for a preferred embodiment of the portable electronic financial calculator 10. The integrated circuit 500 includes an inter integrated circuit bus 510 which is coupled to a CPU 520, a ROM 530, a RAM 540, and a direct-to-analogue converter (‘DAC’) 590. The CPU 520 calculates the solutions to the problems selected by the user. The mathematical relationships used by CPU 520 to solve the financial problems selected by the user are stored in the ROM 530. The information which the user enters into the calculator 10 using the keyboard 30 is stored in the RAM 540 and is automatically saved therein even after the calculator 10 is turned off. The information is discarded once it is replaced by new information entered by the user. The DAC 590 converts digital numerical information from the CPU 510 into an analogue voltage which is proportional to the numerical information having regard to a reference voltage. The analogue voltage then allows the corresponding information to be displayed on the display screen 20.

The inter integrated circuit bus is also coupled to the display screen 20, a clock generator 550 and a timer 560. If the portable financial calculator 10 is left on for a predetermined period of time, for example one minute, as measured by the timer 560, the light means (not shown) which illuminates the display screen 20 during use automatically shuts off. If the portable electronic calculator 10 is left on for an additional predetermined period of time, for example four additional minutes, as measured by the timer 560, the portable financial calculator 10 automatically powers off.

Finally, the inter integrated circuit bus 510 may be coupled to optional elements, such as a low voltage detector 570, an input/output port (‘port’) 580, and a programmable sound generator (‘PSG’) 600. The port 580 would allow the user to connect peripheral devices, such as a keyboard or printer, to the portable financial calculator 10. The PSG could be included in variations of the portable financial calculator 10 which deliver information to the user aurally.

The integrated circuit described above is merely an example. It would be understood by one skilled in the art that a variety of integrated circuits, with innumerable variations, may be used in association with the portable financial calculator 10 of the present invention.

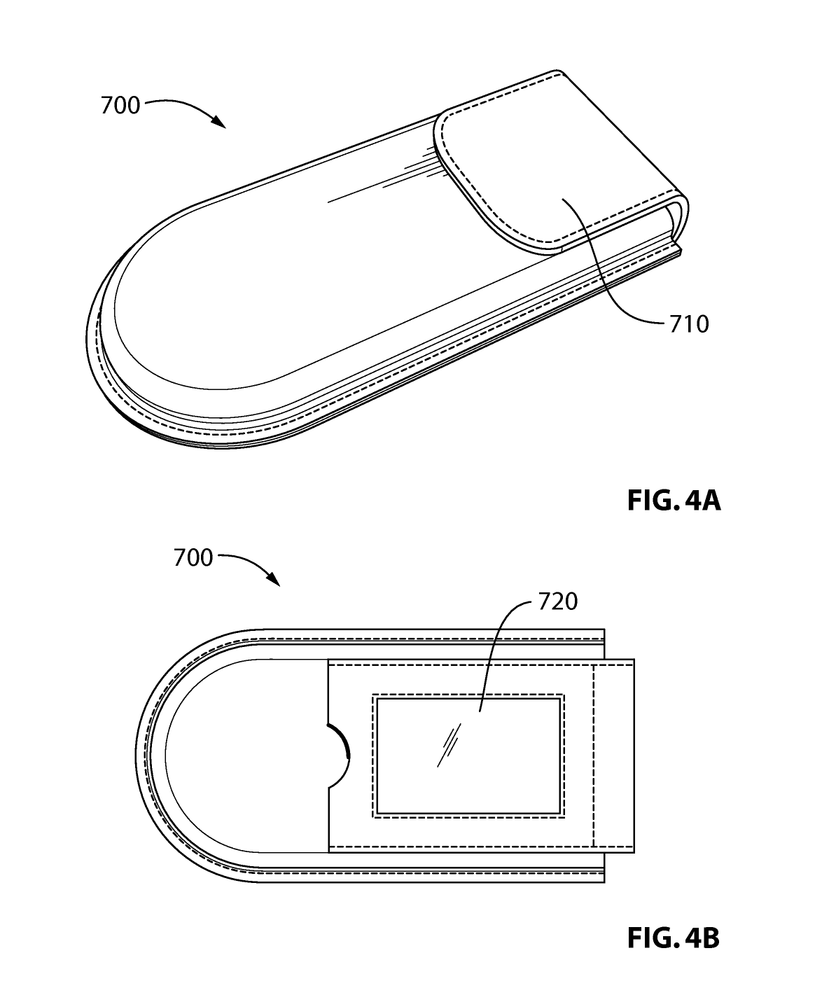

The portable financial calculator 10 is preferably sold with a protective case 700 as illustrated in FIG. 4A and FIG. 4B. The protective case includes a flap 710 which is used to open and close the protective case 700. In the closed position, the flap 710 is held in place against the front of the protective case 700 by means of a magnet. As shown in FIG. 4B, the back of the protective case 700 includes a card holder 720 in which a business card, an identification card, or the like can be placed.

The portable financial calculator 10 is preferably sold with an instruction manual (not shown) which provides plain language instructions for operating the calculator 10. Preferably, the instruction manual and calculator 10 are sold in a package wherein the calculator 10 is placed in front of the manual and visible through a clear bubble (not shown) made of plastic or other suitable material at the front of the package.

The present invention has been described with regard to preferred embodiments. However, it will be apparent to persons skilled in the art that a number of variations and modifications can be made without departing from the scope of the invention as described herein.

The embodiments of the invention in which an exclusive property or privilege is claimed are defined as follows:

1. A portable electronic financial calculator for automatically calculating information pertaining to the time value of money, comprising:
display panel means for displaying various pre-programmed plain language problems for selection, for pre-programmed plain language prompting of certain inputs corresponding to said plain language problem selected, and for receiving entered data in response to said plain language prompting;
input means operatively connected to said display panel means, for selecting among said plain language problems and for inputting information in response to said plain language prompting;
memory means operatively connected to said input means, for storing selection among said plain language problems, for storing said information inputted by said input means, and for storing mathematical relationship between said information and said plain language problem selected;
calculating means operatively connected to said memory means for calculating solution to said plain language problem selected, using said mathematical relationships and said information inputted in response to said plain language prompting; and
output means operatively connected to said calculating means and said display panel means for presenting said solution to said plain language problem selected on said display panel means.

2. The portable electronic financial calculator of claim 1 wherein said solution is presented in plain language.

3. The portable electronic financial calculator of claim 1 further comprising power accommodating means operatively connected to said input means.

4. The portable electronic financial calculator of claim 3 where the power accommodating means is at least one battery terminal.

5. The portable electronic financial calculator of claim 1 wherein only one said problem may be selected at a time.

6. The portable electronic financial calculator of claim 1 wherein the inputs are prompted one input at a time.

7. The portable electronic financial calculator of claim 1 wherein the input means comprises a key pad consisting only of numerical keys 0 to 9, a decimal point key, a clear key for clearing the last entry, a power key for turning the portable electronic financial calculator on and off, a home key for returning to the various plain language problems for selection, and two selection keys.

8. The portable electronic financial calculator of claim 1 wherein the said memory means is capable of automatically storing the said entered data, and wherein the said entered data remains stored until the said entered data is overwritten with new information.

9. The portable electronic financial calculator of claim 1 wherein the portable electronic financial calculator automatically turns off following a pre-determined duration of non-use.

10. The portable electronic financial calculator of claim 1 wherein the portable electronic financial calculator is hand-held.

11. The portable electronic financial calculator of claim 1 wherein the various pre-programmed plain language problems for selection comprise problems having meanings equivalent to the following:
Q1. What is the future value of my savings?
Q2. How much should I save to reach my savings goal?
Q3. How much time until I reach my savings goal?
Q4. What rate of return do I need to reach my savings goal?
Q5. How much should I save for retirement?
Q6. How much income will my savings generate?
Q7. What's my rate of return?
Q8. How long until I pay off my debt?
Q9. What's the total cost of my purchase with interest?
Q10. How much can I afford to borrow?
Q11. What are my monthly loan payments?

12. The combination of the portable electronic financial calculator of claim 1 and a physical manual wherein said manual provides plain language instructions for operating the portable electronic financial calculator.

13. A method for calculating financial information pertaining to the time value of money using a portable electronic financial calculator comprising the steps of:
(a) viewing and navigating through various pre-programmed plain language problems capable of being displayed on a display panel means comprised by said portable electronic financial calculator;
(b) selecting one of said plain language problems;
(c) prompting, by means of plain language prompting displayed on said display panel means, of certain inputs corresponding to said plain language problem selected;
(d) inputting said inputs into said portable electronic financial calculator through input means comprised by said portable electronic financial calculator in response to said prompting;
(e) automatically storing said inputs into a memory means comprised by said portable electronic financial calculator;
(f) calculating a solution to the said problem based on said inputs and based on a pre-programmed mathematical relationship between said inputs and said plain language problem selected;
(g) displaying said solution on said display panel means.

14. The method of claim 13 wherein said solution is displayed in plain language.

15. The method of claim 13 wherein only one said problem is selected at a time.

16. The method of claim 13 wherein said inputs are prompted one input at a time.

17. The method of claim 13 wherein the various plain language problems for selection comprise problems having meanings equivalent to the following:
Q1. What is the future value of my savings?
Q2. How much should I save to reach my savings goal?
Q3. How much time until I reach my savings goal?
Q4. What rate of return do I need to reach my savings goal?
Q5. How much should I save for retirement?
Q6. How much income will my savings generate?
Q7. What's my rate of return?
Q8. How long until I pay off my debt?
Q9. What's the total cost of my purchase with interest?
Q10. How much can I afford to borrow?
Q11. What are my monthly loan payments?
